(19) United States
(12) Patent Application Publication
(10) Pub. No.: US 2013/0020362 A1
(43) Pub. Date: Jan. 24, 2013

(54) BICYCLE HANDLEBAR AND BASKET SUPPORT ASSEMBLY

(71) Applicant: Christopher Luomanen, San Francisco, CA (US)

(72) Inventor: Christopher Luomanen, San Francisco, CA (US)

(21) Appl. No.: 13/185,420

(22) Filed: Jul. 18, 2011

(51) Int. Cl. B62J 7/06

(52) U.S. Cl. 224/420

(57) ABSTRACT

A bicycle handlebar and basket support assembly. The assembly includes a handlebar affixed to a bicycle and a basket support frame permanently affixed to the handlebar. The basket support frame includes first and second segments extending from the handlebar and a third segment connecting the first and second segments creating an open region defined by first, second and third segments. Further included within the assembly is a basket attached to the basket support frame, the basket being of a material different from that of the basket support frame.

### TECHNICAL FIELD

The present invention generally relates to a basket support assembly positioned forward of bicycle handlebars to facilitate the carrying of objects therein. Unlike baskets of the prior art, the present invention contemplates the fabrication of unitary structures composed of the bicycle handlebars and frame components to which the body of the basket is appended.

### BACKGROUND OF THE INVENTION

Bicycle riding both for pleasure and commuting has gained substantial popularity in recent years. Many bicyclists find bicycling an excellent means to exercise while freeing the bicyclist from the constraints of congested vehicular traffic. Others recognize the benefits of travel which is free of a “carbon footprint” as concerns increase over global warming and related issues which are directly impacted by the burning fossil fuels.

As bicycles are used particularly for commuting and in running errands, books, computers, briefcases and groceries must be carried by the bicyclist. Some have suggested saddlebags appended behind the seat and adjacent the bicycle's rear wheel but saddlebags can interfere with the derailer and braking system of the bicycle and if the saddlebags are not evenly weighted, they can tend to destabilize the bicycle.

Alternatively, many bicyclists attach an aftermarket basket forward of the bicycle's handlebars by strapping the basket to the handlebars and/or attaching a support structure to other frame components on the bicycle. Such baskets employ compression stays connected to the bicycle's front fork which distract from the aesthetic look of any bicycle. Although such an approach is preferable to the employment of saddlebags, forward facing baskets of the type suggested by the prior art have not been universally embraced.

Baskets suggested in the past which attach by loops or clamps to a bicycle's handlebars tends to slip, loosen and dislodge in use. When heavy objects such as books or computers are placed in existing baskets, the integrity of the basket can be compromised. Its attachment to the handlebars can loosen causing contents to be lost. When such baskets are made of rigid materials such as metal rods, wire mesh or woven wood or bamboo, objects placed within them can roll from side to side creating a sense of instability particularly as a bicyclist navigates turns. Such baskets are usually permanently affixed to their supporting frame structure such that as the basket is worn, the entire frame assembly must be replaced together with the worn basket portions.

In summary, aftermarket baskets appended to a bicycle's handlebars are considered, at best, a necessary evil that most riders would prefer to not use.

It is thus an object of the present invention to provide a bicycle handlebar and basket support as a unitary assembly for overcoming the disadvantages of the prior art.

These and further objects will be more readily apparent when considering the following disclosure and appended claims.

### SUMMARY OF THE INVENTION

A bicycle handlebar and basket support assembly. The assembly includes a handlebar affixed to a bicycle and a basket support frame permanently affixed to the handlebar. The basket support frame includes first and second segments extending from the handlebar and a third segment connecting the first and second segments creating an open region defined by first, second and third segments. Further included within the assembly is a basket attached to the basket support frame, the basket being of a material different from that of the basket support frame.

### BRIEF DESCRIPTION OF THE FIGURES

FIGS. 1, 2 and 3 are perspective views of examples of the bicycle handlebar and basket support assembly of the present invention.

FIG. 4 is a perspective view of the bicycle handlebar and basket support assembly of FIG. 1 being provided with a typical basket contemplated for use herein.

FIG. 5 is a perspective view of yet a further embodiment of the present invention.

### DETAILED DESCRIPTION OF THE INVENTION

Novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration description only and are not intended as definitions of the limits of the invention. The various features of novelty which characterize the invention are recited with particularity in the claims.

There has been broadly outlined more important features of the invention in the summary above and in order that the detailed description which follows may be better understood, and in order that the present contribution to the art may be appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important therefore, that claims be regarded as including such equivalent constructions insofar as they do not depart from the spirit and scope of the present invention.

Certain terminology and the derivations thereof may be used in the following description for convenience and reference only, and will not be limiting. For example, words such as “upward,” “downward,” “left,” and “right” refer to directions in the drawings to which reference is made unless otherwise stated. Similar words such as “inward” and “outward” refer to directions toward and away from, respectively, the geometric center of a device or area and designated parts thereof. Reference in the singular tense include the plural and vice versa, unless otherwise noted.

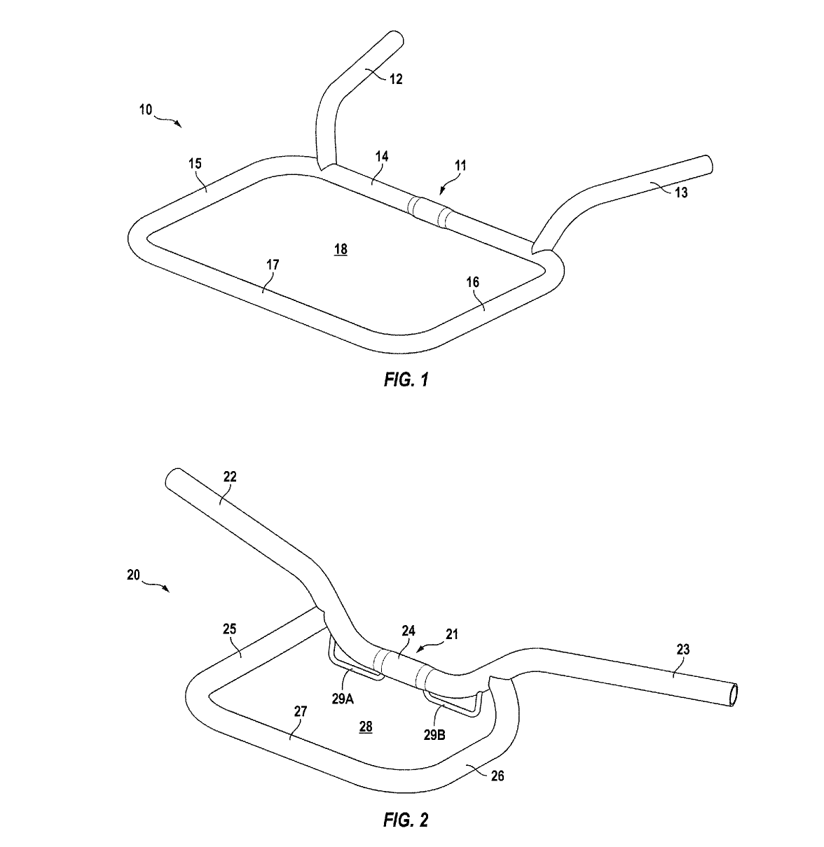

Turning first to FIG. 1, bicycle handlebar and basket support assembly 10 is depicted. Although not shown, handlebar 11 is intended to be affixed in a typical fashion to a bicycle at its stem. Assembly 10 includes, as part of handlebar 11, first and second ends 12 and 13 intended for gripping by a user. Such ends also commonly support brake levers and the like which can be employed in the usual fashion while practicing the present invention.

First and second ends 12 and 13 are connected to central portion 14 of handlebar 11. Prior basket assemblies usually are provided with a clamp or strap for attaching a basket along central portion 14. However, the present invention differs markedly from prior basket embodiments by permanently affixing, by welding or otherwise a basket support frame as shown. Generally, the structure illustrated in FIG. 1 is created as a single piece and installed onto a newly fabricated bicycle or as an aftermarket part replacing preexisting handlebars.

Again referring to FIG. 1, the basket support frame comprises first and second segments 15 and 16 extending forward from central portion 14 and third segment 17 connecting first and second segments 15 and 16 creating open region 18 defined by central portion 14 and first, second and third segments 15, 16 and 17. Open region 18 as shown hereinafter, generally defines the opening in a basket for introducing items to be carried.

FIG. 2 is much like FIG. 1 depicting a modest design variant. In this instance, bicycle handlebar and basket support assembly 20 is of a unitary structure including handlebar 21 having first and second end portions 22 and 23 for gripping by a user and central portion 24 for connecting to first and second end portions 22 and 23. A basket support frame is, again, permanently affixed to central portion 24 comprising first and second segments 25 and 26 extending forward of handlebar 21 and connected to one another by third segment 27 creating open region 28. In this embodiment, subrails 29A and 29B can extend below central portion 24 in order to provide additional contact elements for attaching a suitable basket thereto.

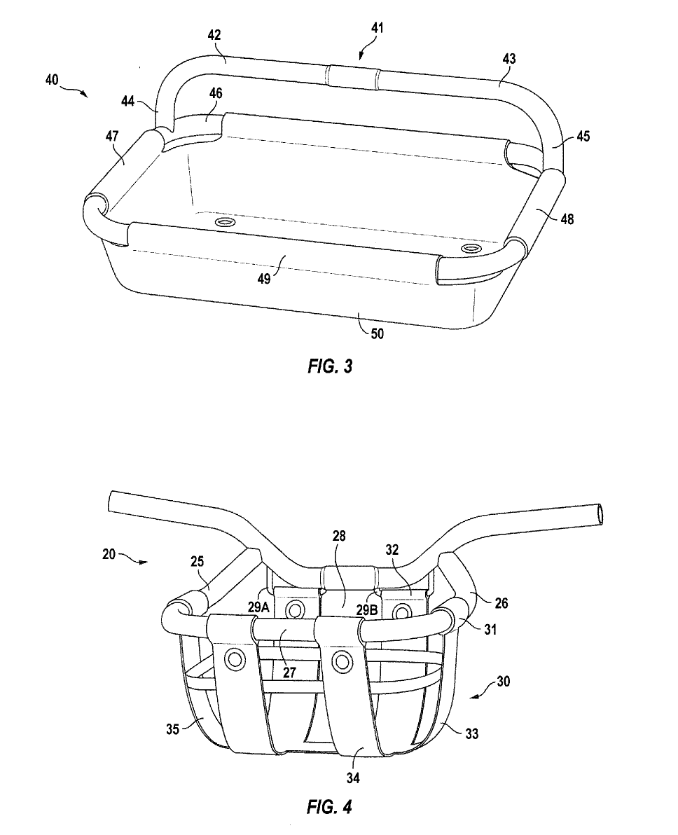

Reference is made to FIG. 4 depicting a typical basket arrangement for use with the bicycle handlebar and basket support assembly 20 of FIG. 2. Turning to FIG. 4, bicycle handlebar and basket support assembly 20 is shown now supporting an appropriate basket noting that basket 30 is comprised of a material different than that of bicycle handlebar and basket support assembly 20. In this embodiment, straps 34 are draped between third segment 27 and support subrails 29A and 29B while perpendicularly extending strap elements 35 are draped between second and third segments 25 and 26. Mesh 33 is then applied to strapping 34 and 35 to prevent small objects from dropping from basket 30.

In viewing FIG. 4, certain advantages of the prior art become readily apparent. It is first noted that, as a preferred embodiment, basket 30 is composed of strapping elements which although shown to be permanently affixed to bicycle handlebar and basket support assembly 20 through grommets, could be attached by snaps, Velcro or the like and, thus as basket 30 is worn, it can be easily replaced while maintaining handlebar and basket support assembly 20 intact.

It should next be appreciated that although the tubular members making up bicycle handlebar and basket support assembly 20 are rigid having been welded together, basket 30 is composed of strapping or fabric which is capable of moving when forces are applied to members 34 and 35. As a result, objects placed within basket 30 do not tend to destabilize the bicycle and its rider particularly when lateral forces are placed upon carried items when the rider makes turns thus changing the angular momentum of the contents within basket 30.

It should further be recognized that although basket 30 is depicted in FIG. 4 as having perpendicularly extending strapping elements, baskets for use herein can be composed of a wide variety of materials including those that are natural or synthetic, hard or soft embracing woven and unwoven fabrics, wire mesh and woven wood and bamboo without departing from the spirit and scope of the present invention. In addition, open region 28 can be covered and a basket can be composed of two or more layers to enable zippers to selectively enclose pockets therein. Other members can be attached to baskets of this type in the usual fashion to support water bottles, keys and cell phones, again, while remaining within the spirit and scope of the present invention.

For the sake of completeness, a further variation of the present invention is depicted in FIG. 3. Specifically, bicycle handlebar and basket support assembly 40 is shown. In this embodiment, a handlebar is depicted having first and second end portions 42 and 43 for gripping by a user which are connected to one another by central portion 41, together constituting the handlebar element of the present invention. Unlike the embodiments of FIG. 1 and FIG. 2 where the basket support assemblies extend substantially horizontally in front of handlebars 11 and 21, respectively, in this instance, the handlebar further includes downward extending curved elements 44 and 45 such that basket 50 resides lower with respect to the bicycle's handlebar than in the previous embodiments.

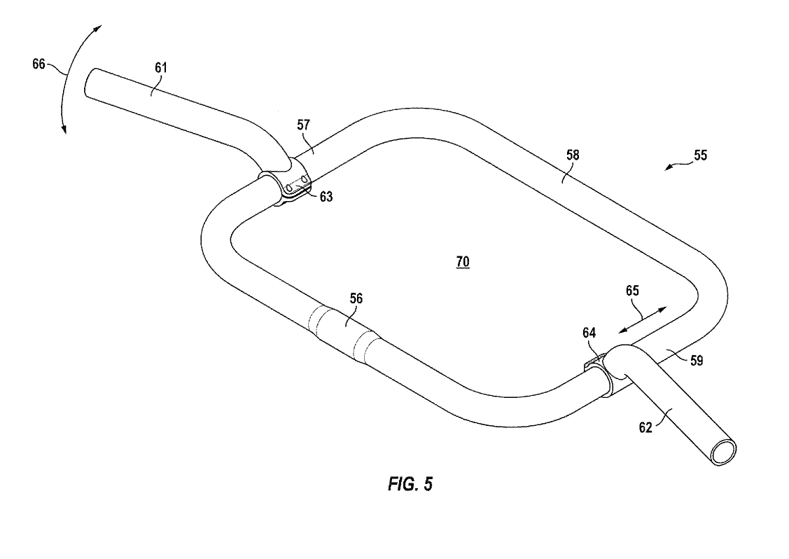

It should further be noted with respect to FIG. 3 that the basket support frame, composed of four rigid segments 46 and 49 running parallel to the handlebar and segments 47 and 48 extending perpendicular thereto, creates a suitable support structure for basket 50. As with the previous embodiments, basket 50 is intended to be made of a material dissimilar from the handlebars and basket support frame elements which, again, are permanently affixed to one another. Basket 50, composed of fabric or a more rigid material such as plastic, on the other hand, can be made removable from segments 46, 47, 48 and 49 such that when basket 50 is worn and needs replacing, replacing basket 50 can be carried out while maintaining the handlebar and basket support frame components as integral parts of a suitable bicycle. Further, although FIGS. 1 and 2 depict two specific handlebar designs, the present invention can be configured of virtually any handlebar design of the prior art. As an example, reference is made to FIG. 5.

FIG. 5 discloses an assembly 55 comprising a plurality of subsections 56, 57, 58 and 59 unitarily and permanently affixed to one another as shown. This can be done by welding the subparts together or by casting the various subparts as a single construction. In the example shown, subsection 56 is intended to act as a bicycle handlebar with subsections 57, 58 and 59 extending forward thereof and creating a basket support frame much like those described above.

The embodiment of FIG. 5 is further characterized as attaching to subsections 57 and 59, at least projections 61 and 62 which are designed for gripping by a bicyclist as one would grip the handlebars of standard prior art configurations. Thus, not only does the assembly of FIG. 5 create open region 70 for support and retention of a basket whose opening is coextensive therewith, but also provides for the independent adjustment and removal of said at least two gripping element 61 and 62 to create a customized gripping orientation for a bicyclist using the present invention. For example, not only can said at least two gripping elements 61 and 62 be removed by removing clamping elements 63 and 64, but by selectively loosening clamping elements 63 and 64, the gripping elements can be moved forward and aft along subsections 57 and 59 as suggested by arrow 65 but also clockwise and counter clockwise thereto as suggested by arrow 66.

The above disclosure is sufficient to enable one of ordinary skill in the art to practice the invention, and provides the best mode of practicing the invention presently contemplated by the inventor. While there is provided herein a full and complete disclosure of the preferred embodiments of the invention, it is not desired to limit the invention to the exact construction, dimensions, relationships, or operations as described. Various modifications, alternative constructions, changes and equivalents will readily occur to those skilled in the art and may be employed as suitable without departing from the true spirit and scope of the invention. Such changes might involve alternative materials, components, structural arrangements, sizes, shapes, forms, functions, operational features or the like. Therefore, the above description and illustration should not be considered as limiting the scope of the invention, which is defined by the appended claims.

What is claimed is:

1. A bicycle handlebar and basket support assembly comprising a handlebar affixed to a bicycle including first and second end portions for gripping by a user and a central portion connecting said first and second end portions, a basket support frame permanently affixed to said central portion, said basket support frame comprising first and second segments extending forward from said central portion and a third segment connecting said first and second segments creating an open region defined by said central portion and said first, second and third segments, said assembly further comprising a basket attached to said basket support frame, said basket comprised of material different from that of said basket support frame.

2. The bicycle handlebar and basket support assembly of claim 1 wherein said handlebar and basket support frame comprise a single structural member.

3. The bicycle handlebar and basket support assembly of claim 1 wherein said basket support frame is affixed to said handlebar by welding.

4. The bicycle handlebar and basket support assembly of claim 1 wherein said basket comprises an opening for gaining access thereto, said opening being coextensive with said open region.

5. The bicycle handlebar and basket support assembly of claim 1 wherein said basket comprises at least one layer of fabric hung from said basket support frame.

6. The bicycle handlebar and basket support assembly of claim 1 wherein said basket is removably appended to said basket support frame.

7. The bicycle handlebar and basket support assembly of claim 1 wherein said basket is permanently affixed to said basket support frame.

8. A bicycle handlebar and basket support assembly comprising a handlebar affixed to a bicycle and a basket support frame permanently affixed to said handlebar, said basket support frame comprising first and second segments extending from said handlebar and a third segment connecting said first and second segments creating an open region defined by said first, second and third segments and a basket attached to said basket support frame, said basket comprised of a material different from that of said basket support frame.

9. The bicycle handlebar and basket support assembly of claim 8 wherein said handlebar and basket support frame comprises a single structural member.

10. The bicycle handlebar and basket support assembly of claim 8 wherein said basket support frame is affixed to said handlebar by welding.

11. The bicycle handlebar and basket support assembly of claim 8 wherein said basket comprises an opening for gaining access thereto, said opening being coextensive with said open region.

12. The bicycle handlebar and basket support assembly of claim 8 wherein said basket comprises at least one layer of fabric hung from said basket support frame.

13. The bicycle handlebar and basket support assembly of claim 8 wherein said basket is removably appended to said basket support frame.

14. The bicycle handlebar and basket support assembly of claim 8 wherein said basket is permanently affixed to said basket support assembly.

15. An assembly comprising a plurality of subsections, unitarily and permanently affixed to one another, a portion of said assembly comprising a handlebar section for attachment to a bicycle, and a plurality of subsections extending forward of said handlebar section which, in combination with said handlebar section, create an open region, a basket attached to said plurality of subsections, and at least two projections extending from two subsections of said assembly for gripping by a bicyclist employing said assemble.

16. The assembly of claim 15 wherein said at least two projections are independently adjustable with respect to said plurality of subsections.

17. The assembly of claim 15 wherein said at least two projections are independently removable with respect to said plurality of subsections.

18. The assembly of claim 15 wherein said basket is selectively removable from said plurality of subsections.

19. The assembly of claim 15 wherein said basket comprises and opening for gaining access thereto, said opening being coextensive with said open region.

20. The assembly of claim 15 wherein said plurality of subsections comprise a single structural member.
